(19) United States
(12) Patent Application Publication
(10) Pub. No.: US 2023/0117455 A1
(43) Pub. Date: Apr. 20, 2023

(54) PAINT PAN COVER

(71) Applicant: Cory R. Zenger, Salt Lake City, UT (US)

(72) Inventor: Cory R. Zenger, Salt Lake City, UT (US)

(21) Appl. No.: 17/502,862

(22) Filed: Oct. 15, 2021

(51) Int. Cl. B44D 3/12; B65D 51/24; B65D 43/02

(52) U.S. Cl. CPC B44D 3/126; B65D 51/24; B65D 43/0212; B65D 43/0222; B65D 2543/00194; B65D 2543/00722; B65D 2543/00527; B65D 2543/00537; B65D 2543/00805

(57) ABSTRACT

The present invention is directed to a cover or lid which fastens about the lip of standard-sized paint trays. The lid substantially seals paint and a roller assembly in the tray from ambient air. The lid also holds the roller assembly in place to prevent undesired movement of the rollers assembly in the tray.

### BACKGROUND OF THE INVENTION

### 1. Field of the Invention

The present invention relates to paint tray cover for covering a paint tray between intermittent uses. The cover prevents the surface of the paint from drying or forming a dried film and at the same time keeps the paint roller moist and prevents drying of the paint roller. The cover also prevents spills when the paint tray in inadvertently bumped. The cover also prevents undesirable airborne particles, dust or other substances from landing in the paint.

The cover generally comprises a surface whose lateral edges are configured to fit about or against the paint tray to form a substantially sealing union between the cover and the tray. The cover includes a raised portion along the length of the cover to accommodate a paint roller under the raised portion. The cover also includes a port through which a portion of the roller assembly may extend outside the cover while the cover is yet in place.

In use, when there is a break in painting, the roller portion may be rested midway in the paint tray in the paint with portion of the roller assembly resting upon a lip of the paint tray with at least a portion of the handle and/or shaft extending outward from the paint tray. The cover is placed over the paint tray with the handle protruding out of and beyond the cover. In this way, the cover shields the remaining paint in the tray and on the roller from the otherwise drying and/or contaminating effect of the ambient air thereby allowing painting to resume without fouled paint in the tray or on the paint roller.

### 2. Background and Related Art

Different paint tray covers are disclosed in the prior art. For example, the SealPro Core-Gear CG006 Resealable Paint Tray is a rigid, plastic combination tray and cover system. The tray includes an interior troughed receiver on which the paint roller handle is placed such that the entire paint roller, roller shaft and handle are stored within the paint tray adjacent the remaining paint. The cover covers the entire paint tray, paint roller handle, shaft and roller portion while providing a covering for the roller portion at one end of the tray. The SealPro is manufactured of rigid plastic and is designed for reuse.

Also disclosed is a paint tray cover of U.S. Design Pat. No. 400,329 issued Oct. 27, 1998. This design also covers the roller at one end of the tray.

These designs do not disclose the combined structure and function of the present invention. Accordingly, it would be an improvement in the art to provide an apparatus which simultaneously seals the paint and roller from ambient air to retain paint moisture while securing the paint roller handle in place and away from paint in the tray.

### SUMMARY OF THE INVENTION

The present invention relates to apparatuses for both sealing paint in a paint tray and securing the paint roller from undesired movement. The same device that shields paint in the paint tray and on the paint roller also prevents paint roller and its handle from inadvertent and/or undesirable movement. The paint tray apparatus of the present invention accomplishes both functions at the same time during use.

In particular, the present invention is directed to a cover or lid which fastens about the lip of standard-sized paint trays. The lid seals paint in the tray from ambient air. The lid also holds the roller portion of the paint roller in the paint and the handle of the paint roller in place to prevent movement of the paint rollers.

The present invention for a paint tray cover comprises a low-profile, reusable or disposable cover or lid of light-weight material. The cover comprises a top member having a length, a width and a boundary edge configured to fasten or snap about an upwardly extending lip of a standard paint tray. The edge configuration of the cover may comprise a plurality of downwardly extending tabs or flanges which engage the lip of the tray in a friction or snap fit mating arrangement.

The top member may comprise one or more lateral ribs to provide structural strength along the top member. The ribs may run along the length and/or along the width of the top member. The one or more ribs may be either raised or recessed.

The top member may also comprise a rounded, raised portion across the width of the top member, the rounded, raised portion. The rounded, raised portion is configured to receive an upper portion of the roller portion of the paint roller lying within the paint in the underlying tray. The rounded, raised portion of the top member is positioned a distance away from the ends of the length of the top member such that when the paint roller is rested within the tray, the roller portion remains in the paint while the handle of the paint roller is laterally adjacent the lip of the tray.

The top member also may comprise a roller assembly port at the edge of the top member adjacent the roller handle. The port is configured with an opening to allow a portion of the roller handle and/or the shaft of the roller to enter under the cover. The port may be either raised or recessed depending upon the vertical height of the edge of the top member. The size of the port opening may comprise a size substantially coextensive with the cross-section of the roller handle or roller shaft thereby sealing the underside of the top member from the ambient environment. The lateral location of the port and its relation to the roller handle and/or roller shaft, together with the rounded, raised portion of the top member act together to hold the roller assembly in place when the cover is in place.

The low-profile nature of the present invention also contemplates that raised or recessed portions of the top member may be properly sloped relative to each other to permit efficient stacking of a plurality of covers.

These and other features and advantages of the present invention will be set forth or will become more fully apparent in the description that follows and in the appended claims. The features and advantages may be realized and obtained by structure outlined methods and particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a top perspective view of one embodiment of the paint tray cover of the present invention with the paint roller assembly shown in dotted lines;

FIG. 2 illustrates a top, plan view of one embodiment of the paint tray cover of the present invention;

FIG. 3 illustrates a side view of one embodiment of the paint tray cover of the present invention;

FIG. 4A illustrates a port-facing end view of one embodiment of the paint tray cover of the present invention;

FIG. 4B illustrates an opposing end view of one embodiment of the paint tray cover of the present invention;

FIGS. 5A-5E illustrate exemplary configurations of the opening of the port of the paint tray cover of the present invention.

### DETAILED DESCRIPTION OF THE INVENTION

The apparatus of the present invention relates to a substantially low-profile paint tray cover used to seal a paint tray and paint roller assembly from the dilatory effects of the ambient environment when the roller assembly is not in use for painting. From time to time, continued use of a paint roller is interrupted or discontinued for a given period of time. The paint tray cover of the present invention allows a painter to effectively seal the paint tray, its contents, and the roller assembly in a moist environment so that painting may resume upon demand with any paint contamination, drying or spilling.

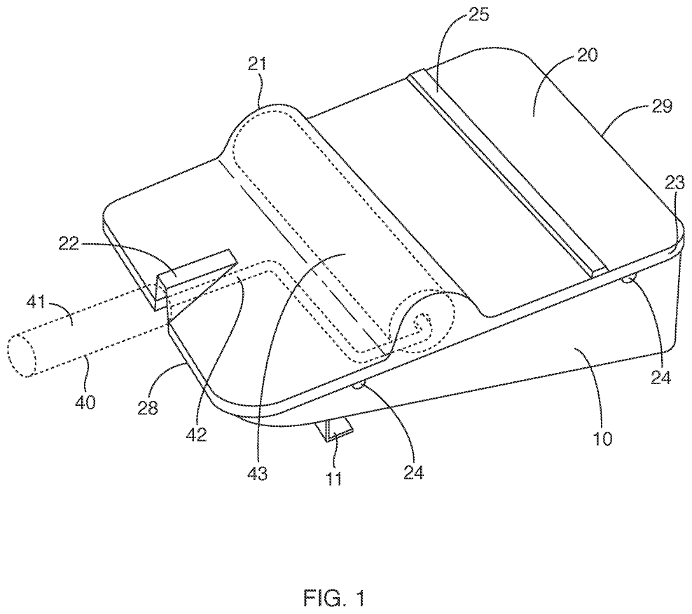

FIG. 1 shows a top perspective view a standard paint tray 10 with leg(s) 11. Tray 10 is sealed with cover or top member 20. Cover 20 comprises a low-profile configuration.

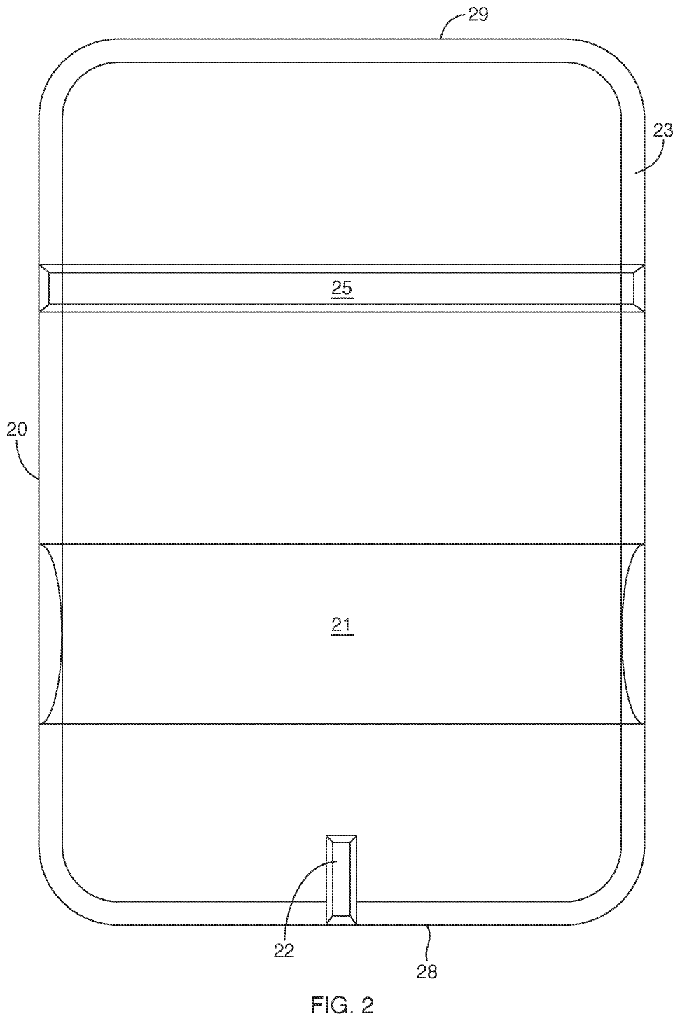

As shown in FIGS. 1 and 2, top 20 comprises a length and a width. Top 20 may also comprise a rounded, raised portion 21, a port 22 at a proximal end 28 of top 20, an edge 23, a plurality of securing tabs or flanges 24 along edge 23 and a rib 25 position near a distal end 29 of top 20. Also show in phantom or dotted lines is a roller assembly 40 comprising a handle 41, a roller shaft 42, and a paint roller portion 43.

Rounded, raised portion 21 is configured to permit roller portion 43 to be positioned within tray 10 along a standard sloped ramp such that a part of roller portion 43 is held immersed in standing paint but the shaft portion 42 is not immersed in standing paint. Rounded portion 21 of cover 20 is disposed along the length of cover 20 from side to side and a distance away from proximal end 28 and distal end 29. Preferably the crest of rounded portion 21 is disposed from end 28 a distance substantially the same as the roller shaft displacement of roller assembly 40 defined herein as the lateral distance between roller handle 41 and the axis of roller portion 43.

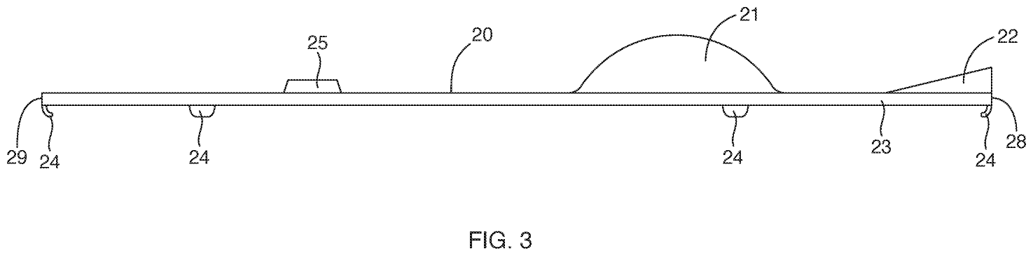

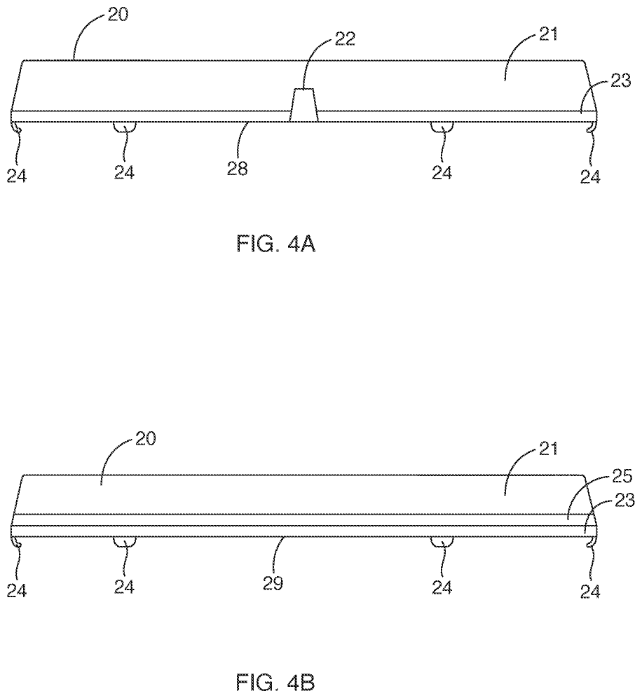

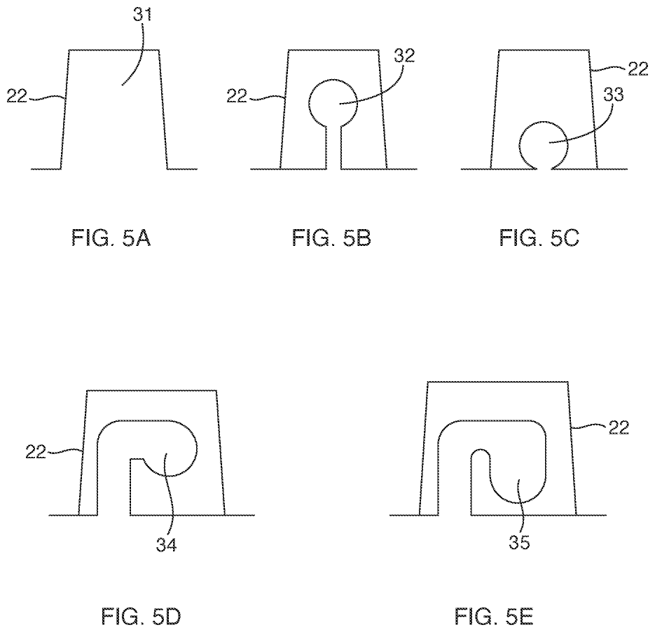

Port 22 disposed at a proximal end 28 of top member 20 may comprise a raised entry, see FIGS. 1, 2, 3, 4A and 5A-5E. In one embodiment, port 22 is disposed near the midpoint of the width of cover 20. Port 22 defines an opening, see openings 31-35 of FIGS. 5A-5E, through which opening a portion of roller assembly 40 may pass under cover 20. For example, roller handle 41 my rest near or in opening 31. In the alternative, roller shaft portion 42 may be inserted into and rest in openings 32-35 or port 22 with shaft portion 42 substantially sealing openings 32-35.

Port 20 is positioned near edge 23 such that the roller shaft displacement positions handle 41 near, against or in opening 31-35, see FIG. 1, to substantially seal the opening of port 22 to block movement of ambient air in and out of the moist environment under cover 20 when cover 20 is placed upon tray 10. The same sealing principles may be applied in an alternative embodiment of port 22 in which port 22 is configured in a recessed fashion into tray 10 instead of in a raised configuration, not shown.

In this way, the roller shaft displacement holds roller portion 43 in place under rounded, raised portion 21 of top member 20 in a lower profile in paint and simultaneously holds roller shaft 42 away from paint and positions roller handle 41 near or at edge 23 upon an upper lip of tray 10. This roller shaft displacement in conjunction with rounded, raised portion 21 and port 22 also prevents inadvertent movement of roller assembly 40 and its handle 41 in any undesirable direction.

Edge 23 circumscribes cover 20 coextensive with tray 10 such that edge 23 rests upon or against tray 10 to seal cover 20 over tray 10. Edge 23 or a portion of edge 23 may comprise a downwardly extending brim to overlap or engage an upwardly extending lip of tray 10 on the inside or outside of tray 10 to temporarily and releasably affix cover 20 to tray 10 in a friction fit, snap fit or overlay configuration, see FIG. 2. In an alternative embodiment, edge 23 may comprise a plurality of downwardly extending tabs or flanges 24 to temporarily and releasably affix tray 10 to secure cover 20 to tray 10, see FIGS. 1, 3, 4A, and 4B. In still another embodiment, a combination of a downwardly extending brim along a portion of edge 23 with one or more tabs 24 may be employed to temporarily and releasably affix cover 20 to tray 10. Preferably, the brim of edge 24 and tabs 24 are flexible. While a friction or snap fit configuration is illustrated, any releasable mechanism may be used which temporarily and releasably affixes cover 20 to tray 10 such as a c-channel on the underside of cover 20 to receive an upward lip of tray 20, and the like. In an alternative embodiment, a portion or configuration of tray 10 such as flexible tabs may engage cover 20 to provide an equivalent fastening.

Rib 25 is shown in FIGS. 1, 2, 3, and 4B in a raised construction. One or more ribs 25 may be placed along top 10. Rib(s) 25 provide structural integrity across the width of top 20 to prevent sagging or twisting of top 20. While rib 25 is illustrated in a raised construction, rib 25 could be constructed in a recessed construction, or ribs 25 could be a combination of raised or recessed construction. Rib(s) 25 may be placed on either side of rounded, raised portion 21 as needed for strength.

Utilizing the elements of the apparatus of the present invention, cover 20 has a superior, lower-profile, maintain a portion of roller 42 in paint, keeps handle 41 and shaft 42 away from paint in the tray, and secures roller assembly 40 with tray 10 to avoid movement of roller assembly 40 and/or handle 41 or shaft 42 in any undesired direction thereby providing advantages over the prior apparatuses.

Cover 20 and its component parts may be manufactured from any suitable material that is sufficiently rigid to span tray 10 without material sagging to prevent cover 20 from resting on paint in tray 10, to provide sufficient sealing of cover 20 on tray 10, and to provide sufficient rigidity and flexibility for edge 23 to engage tray 10. Preferably, cover 20 comprises a recycled or recyclable, solvent-resistant, thin-walled. resilient, flexible plastic. As such, cover 20 is economically disposable after one or more uses. Cover 20 may be transparent, translucent or opaque.

Cover 20 may be constructed in any number of ways, including but not limited to pressing, casting, molding, injection molding, and/or pattern assembly.

As illustrated in FIGS. 1, 2, 4A, 4B and 5A-5E, rounded, raised portion 21, port 22 and rib 25 transition along top 20 with tapered portions of roller portion 21, port 22, and rib 25. This tapering facilitates both mold extraction during construction and stacking for efficient shipping and storage.

In use, a painter uses roller assembly 40 in a conventional way to paint. When painting is interrupted or discontinued, roller assembly 40 is placed in tray 10 with handle 41 on or near the lip of tray 10. Cover 20 is placed over the contents of tray 10 with edge 23 or tabs 24 engaging tray 10 in a friction or snap fit configuration to temporarily and releasably affix cover 20 to tray 10 with rounded, raised portion 21 positioned over and/or engaging roller portion 43 of roller assembly 40 and with port 22 positioned over, near or about handle 41 or shaft 42. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A cover apparatus for a paint tray and paint roller assembly having a shaft portion, the cover comprising:
a length with a proximal end and a distal end;
a width, wherein the length and width are at least substantially laterally coextensive to the paint tray;
a raised portion to engage a roller portion of a roller assembly, the raised portion disposed from the proximal end a distance substantially equal to a roller shaft displacement of the roller assembly;
a port disposed near the proximal end of the cover, the port defining an opening through which a portion of the roller assembly passes;
means for temporarily and releasably affixing the cover against the paint tray to substantially seal the cover against the tray, and
means for substantially sealing the opening of the port against the surface of a portion of the roller assembly to block movement of ambient air in and out of the moist environment under the cover when the cover is placed upon the paint tray.

2. The apparatus of claim 1 further comprising one or more ribs along the length or width.

3. The apparatus of claim 1 wherein the port opening comprises a size substantially coextensive with the cross-section of a roller handle or roller shaft.

4. The apparatus of claim 1 wherein the port is disposed near the midpoint of the width of the cover.

5. The apparatus of claim 1 wherein the means for temporarily and releasably affixing the cover against the paint tray comprises a friction or snap fit arrangement between the cover and the tray.

6. The apparatus of claim 5 wherein the friction or snap fit arrangement between the cover and the tray comprises tabs extending downwardly from the cover to engage the tray.

7. The apparatus of claim 1 wherein the means for temporarily and releasably affixing the cover against the paint tray comprises an edge of the cover which overlaps the tray.

8. The apparatus of claim 7 wherein a portion of the edge engages a portion of the tray.

9. A system to preserve the moisture of paint and a paint roller assembly having a shaft portion in a paint tray, the system comprising:
a paint tray; and
a cover comprising:
a length with a proximal end and a distal end;
a width, wherein the length and width are at least substantially laterally coextensive to the paint tray;
a raised portion to engage a roller portion of a roller assembly, the raised portion disposed from the proximal end a distance substantially equal to a roller shaft displacement of the roller assembly;
a port disposed near the proximal end of the cover, the port defining an opening through which a portion of the roller assembly passes;
means for temporarily and releasably affixing the cover against the paint tray to substantially seal the cover against the tray; and
means for substantially sealing the opening of the port against the surface of a portion of a roller assembly to block movement of ambient air in and out of the moist environment under the cover when the cover is placed upon the paint tray.

10. The system of claim 9 wherein the cover further comprises one or more ribs along the length or width.

11. The system of claim 9 wherein the port opening comprises a size substantially coextensive with the cross-section of the roller handle or roller shaft.

12. The system of claim 9 wherein the port is disposed near the midpoint of the width of the cover.

13. The system of claim 9 wherein the means for temporarily and releasably affixing the cover against the paint tray comprises a friction or snap fit arrangement between the cover and the tray.

14. The system of claim 13 wherein the friction or snap fit arrangement between the cover and the tray comprises tabs extending downwardly from the cover to engage the tray.

15. The system of claim 9 wherein the means for temporarily and releasably affixing the cover against the paint tray comprises an edge of the cover which overlaps the tray.

16. The system of claim 15 wherein a portion of the edge engages a portion of the tray.
